(19) United States
(12) Patent Application Publication
(10) Pub. No.: US 2006/0217449 A1
(43) Pub. Date: Sep. 28, 2006

(54) Interconnected bubbles solutions

(76) Inventor: Daniel M. Ammon, Penfield, NY (US)

Correspondence Address: Kevin D. McCarthy;Roach Brown McCarthy & Gruber, P.C., 1620 Liberty Bldg., 420 Main St., Buffalo, NY, 14202, US

(21) Appl. No.: 11/441,548

(22) Filed: May 26, 2006

Related U.S. Application Data
(63) Continuation-in-part of application No. 10/392,037, filed on Mar. 19, 2003.

(51) Int. Cl. B01F 17/00

(52) U.S. Cl. 516/10

(57) ABSTRACT

The present invention is directed to a product and a method of making that product. The product is a unique bubble making solution that when bubbles are formed each bubble is interconnected to another bubble by a string of bubble solution. Admittedly, a portion of the bubble solution is known to those of ordinary skill in the art. That known portion is referred to as the fundamental bubble solution and it comprises at least one surfactant, at least one plasticizer, and water. From that fundamental bubble solution, the inventors add an effective amount of an organic polymeric resin having a molecular weight greater than 3 million. With that high molecular weight polymer, each formed bubble is interconnected to another bubble.

### CLAIM OF PRIORITY

This application claims priority as a continuation-in-part patent application to U.S. patent application Ser. No. 10/392,037, which was filed on Mar. 19, 2003.

### FIELD OF THE INVENTION

The present invention is directed to bubble formulations.

### BACKGROUND OF THE INVENTION

Bubbles have been manufactured for many years. Some bubble formulations are easy to manufacture. For example, many parents create bubble solutions by mixing dishwashing soap and water.

Water varies widely in its quality. Soft water is good for bubbles. Hard water, well water, and any water containing high levels of iron are bad for bubbles. To get the best mixture, it appears to be agreed upon that distilled water is the preferred water source.

The soap decreases the surface tension of the water. There are numerous varieties of soap that can be used. Some are conventional dishwashing soaps and others use the active ingredients in such dishwashing soaps. Such active agents include and are not limited to sodium lauryl sulfate, C₁₂H₂₅NaO₄S. This active agent is useful in a wide variety of personal care applications in which viscosity building and foam characteristics are of importance. It is compatible with alkanolamides and amphoterics so that maximum optimization of foam and viscosity characteristics can be reached in the finished product.

The parent then gives the solution to its child. To obtain the maximum result, the parent should delay giving the solution to the child for at least 12 hours. As expected, the child 8 dips, and many times spills the solution on the ground, an aperture 12 of a conventional bubble wand 10 into the solution. A film is then formed across the aperture 12. The child 8 then pushes a gas, normally its breadth, against one surface of the film. The film is then displaced from the apertured surface and produces a free-floating bubble 14. Each bubble 14 is normally a single bubble, as illustrated in FIG. 1.

From such bubbly foundations, the bubble industry has burst into specialty bubble formulations. In particular, Joseph Ehrlich, in U.S. Pat. No. 4,511,497, identifies that there are a great variety of bubble solution formations. These formulations have been suggested to feature special effects in bubble making.

In particular, Ehrlich discloses many “solutions for making large bubbles, long lasting bubbles, deep colored bubbles, split bubbles, self-healing bubbles, multiple bubbles, vanishing bubbles, bursting bubbles, high and/or far-flying bubbles, sinking bubbles,” and bead-forming bubbles (collectively referred to as “Special Effects”). See col. 1, lines 10-15.

A split bubble has a flap positioned within the individual bubble 14. That means the split bubble looks like a dissected aorta as illustrated in a CT scan image. A split bubble does not form an interconnection of a bubble solution string 16 that connects a first bubble 14a to a second bubble 14b as illustrated in FIG. 2 of the present application and as claimed.

Bead forming bubbles are disclosed as “long-floating bubbles which, when allowed to float at least for 15 to 20 (sic) second, will eventually settle down (sic) of the ground or cling to other solid objects without breaking. Such bubbles form transparent, completely spherical beads which cling to solid objects just with one single point of their surface and can stay there for many hours before collapsing to a jelly mass.” Col. 7, lines 12-19 of the '497 patent.

In any case, many of these formulations are found in U.S. Pat. No. 4,511,497. Many of Ehrlich's specialty bubble solutions use a soap—for example, sodium lauryl sulfate—, water, and a plasticizer—for example glycerin, Karo syrup and linseed oil. These plasticizers are recognized by bubble experts as having the ability to make a bubble more sturdy and colorful.

From these three fundamental specialty bubble ingredients—a soap, water and a plasticizer—, Ehrlich adds other ingredients to obtain the Special Effects. One of those other ingredients is an organic polymeric resin. Ehrlich discloses, at col. 2 lines 14-19, that acceptable organic polymeric resins for bubble solutions have a “typical molecular weight range from 60,000 to 1,000,000 . . . .” In other words, Ehrlich teaches that for a bubble solution to have the ability to form certain Special Effects (previously defined as “solutions for making large bubbles, long lasting bubbles, deep colored bubbles, split bubbles, self-healing bubbles, multiple bubbles, vanishing bubbles, bursting bubbles, high and/or far-flying bubbles, sinking bubbles,” and bead-forming bubbles (collectively referred to as “Special Effects”), the solution should contain an organic polymeric resin having a molecular weight that should not significantly exceed 1 million. One million for the molecular weight of the polymeric resin appears to be critical for the formation of Erlich's Special Effect bubbles for children's use.

In particular, Ehrlich uses methyl cellulose as its example for the organic polymeric resin. Methyl cellulose does not have the correct visco-elastic properties to form the claimed bubbles interconnected by a string. At best, Ehrlich's bubble solution produces individual bubbles 14 as illustrated in FIG. 1.

In WO 02/09819 A2, Ansul discloses an “aqueous foamable concentrate.” Ansul's aqueous foamable concentrate is “mixed with a non-neutral pH aqueous liquid and foamed, the resulting foam is suitable for blanketing and neutralizing non-neutral pH hazardous material spills.” See Ansul's Abstract. The polymeric resin in the foamable concentrate has a molecular weight of over 2 million. That molecular weight value is normally used to form foam for cleaning purposes.

Ansul's foam bubbles also contact each other. Ansul's foam bubbles have a first bubble 100 interconnect to a second bubble 100 through a large surface area of the first bubble contacting a large surface area of the second bubble as illustrated in FIG. 3. There is no string of bubble solution that interconnects Ansul's first bubble to Ansul's second bubble as claimed and illustrated in FIG. 2. Moreover, Ansul's foam bubbles are for cleaning purposes (in particular, cleaning hazardous spills and it is used to neutralize non-neutral pH hazardous material spills) and not to be played with by young children.

It is known that young children (and overgrown children) like to blow bubbles. The present invention uses a well known technique to blow bubbles that is simple and easy for a child to use. The conventional blowing bubble technique, which is clearly in the public domain, is as follows: (a) a child (or overgrown child—like an adult) inserts a bubble wand having a single aperture into a container having the claimed bubble solution, (b) the child removes the bubble wand from the container so there is a film of bubble solution across the wand's aperture, (c) the child (i) positions the single aperture near its mouth and begins blowing or (ii) waves the wand and (d) bubbles are formed. This definition of “conventional blowing bubble technique” is to be applied to the language set forth in the claims. It should be noted that in the prior art, the bubbles formed by the conventional blowing bubble technique are not interconnected by a string of bubble solution as claimed.

During the prosecution of the parent application, it was suggested bubbles interconnected by a bubble solution string may be created by using (a) two wands having different apertures or (b) a single wand with two different sized apertures. Applicant does not understand how a user:

(1) forms
(a) two large bubbles from a wand having a first aperture and
(b) at least two string bubble designs from
   (i) the wand with a second and smaller aperture or
   (ii) a second wand with a smaller aperture than the first wand aperture, and

(2) interconnects
(a) the first string bubble to the first and second large bubbles and
(b) the second string bubble to the second large bubble to possibly interconnect to a third large bubble without extremely good dexterity and precision which most children and overgrown children do not possess.
   That proposed technique would make Rube Goldberg proud.

Notwithstanding the above-identified hypothetical technique, the present invention is directed to a bubble composition that can be used by children (and overgrown children) using the conventional bubble blowing technique described above to form a first bubble interconnected to a second bubble through a string of bubble solution as illustrated in FIG. 2.

In view of all this information, Applicant is unaware of any bubble formation that is designed to create a plurality of bubbles wherein each bubble is interconnected to another bubble through a string of bubble solution by using a conventional bubble blowing technique. The present invention solves this problem.

### SUMMARY OF THE INVENTION

The present invention is directed to a product and a method of making that product. The product is a unique bubble making solution that when bubbles are formed each bubble is interconnected to another bubble by a string of bubble solution. Admittedly, a portion of the bubble solution is known to those of ordinary skill in the art. That known portion is referred to as the fundamental bubble solution and it comprises at least one surfactant, at least one plasticizer, and water. From that fundamental bubble solution, the inventors add an effective amount of an organic polymeric resin having a molecular weight greater than 3 million. With that high molecular weight polymer, each formed bubble is interconnected to another bubble.

### BRIEF DESCRIPTION OF THE DRAWINGS

FIG. 1 illustrates a child forming conventional bubbles.

FIG. 2 illustrates a child forming bubbles of the present invention.

FIG. 3 illustrates a bubble formation that does not fall within the ambit of the present invention.

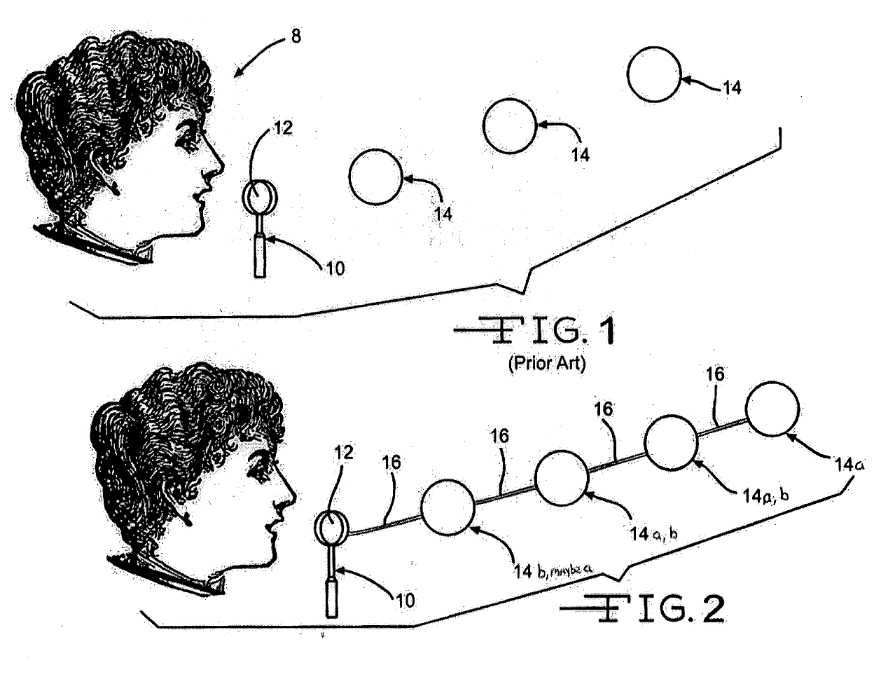

### DETAILED DESCRIPTION OF THE INVENTION

The present invention is directed to a unique bubble solution. This bubble solution is designed to form bubbles from a conventional bubble blowing apparatus—a bubble wand of any shape or material—wherein each bubble is interconnected to another bubble.

As with any specialized bubble solution, the bubble solution contains at least one soap, water and at least one plasticizer. As stated above, those three ingredients are the foundation for all specialized bubble solutions (“Foundation Solution”).

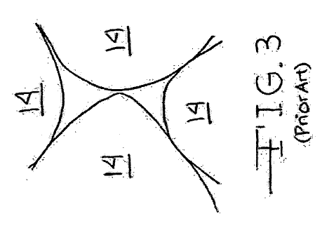

By adding an organic polymeric resin material having a molecular weight ranging from 3 million to 15 million to a Foundation Solution, the inventor determined that a resulting first bubble 14a will interconnect to a resulting second bubble 14b through by a line (a string) of bubble material 16 as illustrated in FIG. 2. The string of bubble material 16 has a distance (d1) between the first bubble 14a and the second bubble 14b that is greater than the diameter (d2) of the string 16, which is illustrated at FIG. 2. That string parameter clearly distinguishes the present invention from those bubble solutions that merely have the bubbles contact each other in a foam application as illustrated in FIG. 3. Applicant is unaware of any bubble solution that creates the effect illustrated in FIG. 2.

In a preferred embodiment, the organic polymeric resin material having a molecular weight ranging from 3 million to 15 million has a molecular weight of around 7 million. In addition, the organic polymeric resin material can be any organic polymeric resin having an oxygen element therein. Such organic resin materials include and are not limited to polyethylene oxide, polypropylene oxide, and methoxy cellulose. To obtain a desired result, the organic polymeric resin material should be about 0.01 to 4% of the bubble solution. Preferably the percentage is about 0.1 to 1.2% and most preferred 0.8%, of the bubble solution.

### EXAMPLE 1

0.8% PEO having a molecular weight of about 7 million 3% a plasticizer—for example glycerin

7% a soap—for example 30% solution of sodium lauryl sulfate

3% a soap—bubble stabilizer—for example a 30% solution of Cocamidopropyl Betaine

Remainder is water and conventional preservatives.

### EXAMPLE 2

15% PEO having a molecular weight less than 1 million to form “snow flakes” once the bubbles burst

0.8% PEO having a molecular weight of about 7 million

3% a plasticizer—for example glycerin

7% a soap—for example 30% solution of sodium lauryl sulfate

3% a soap—bubble stabilizer—for example a 30% solution of Cocamidopropyl Betaine

Remainder is water and conventional preservatives.

The addition of an organic polymeric resin with a molecular weight greater than 3 million, and preferably ranging from 3 million to 15 million, to any conventional Special Effects Bubble Solution, as described by Ehrlich in U.S. Pat. No. 4,511,497, results in each bubble being interconnected to another bubble by a string of bubble solution as illustrated in FIG. 2.

While the preferred embodiment of the invention has been illustrated and described, it will be clear that the invention is not so limited. Numerous modifications, changes, variations, substitutions and equivalents will occur to those skilled in the art without departing from the spirit and scope of the present invention as defined by the appended claims.

We claim:

1. A bubble solution having at least one surfactant, at least one plasticizer, and water to form a fundamental bubble solution, the bubble solution comprising:
an effective amount of an organic polymeric resin so that when bubbles are formed from a conventional bubble blowing technique, as defined in the specification, each bubble is interconnected to another bubble and the interconnection is a string of bubble solution wherein the string distance between the bubbles is at least greater than the diameter of the string.

2. The fundamental bubble solution of claim 1 wherein the organic polymeric resin has a molecular weight, on the weight average molecular weight, greater than 3 million.

3. The fundamental bubble solution of claim 2 wherein the effective amount of the organic polymeric resin ranges from 0.01 to 4% of the fundamental bubble solution.

4. The fundamental bubble solution of claim 3 wherein the effective amount of the organic polymeric resin is from 0.1 to 1.2% of the fundamental bubble solution.

5. The fundamental bubble solution of claim 3 wherein the effective amount of the organic polymeric resin is about 0.8% of the fundamental bubble solution.

6. The fundamental bubble solution of claim 1 wherein the molecular weight of the organic polymeric resin is 3 million to 15 million.

7. The fundamental bubble solution of claim 6 wherein the molecular weight, on the weight average molecular weight, of the organic polymeric resin is about 7 million.

8. The fundamental bubble solution of claim 1 wherein the organic polymeric resin is any organic polymeric resin having an oxygen element therein.

9. The fundamental bubble solution of claim 8 wherein the organic polymeric resin having an oxygen element therein is selected from the group consisting of polyethylene oxide and cellulose and derivatives thereof.

10. A method to form a bubble solution having at least one surfactant, at least one plasticizer, and water to form a fundamental bubble solution, the process comprising:
adding an effective amount of an organic polymeric resin having a molecular weight, on the weight average molecular weight, greater than 3 million into a fundamental bubble solution;
wherein when bubbles are formed from a conventional bubble blowing technique, as defined in the specification, each bubble is interconnected to another bubble and the interconnection is a string of bubble solution wherein the string distance between the bubbles is at least greater than the diameter of the string.

11. The method claim 10 wherein the effective amount of the organic polymeric resin having a molecular weight, on the weight average molecular weight, greater than 3 million ranges from 0.01 to 4% of the fundamental bubble solution.

12. The method of claim 10 wherein the effective amount of the organic polymeric resin is from 0.1 to 1.2% of the fundamental bubble solution.

13. The method of claim 10 wherein the effective amount of the organic polymeric resin is about 0.8% of the fundamental bubble solution.

14. The method claim 10 wherein the molecular weight, on the weight average molecular weight, of the organic polymeric resin is 3 million to 15 million.

15. The method of claim 14 wherein the molecular weight, on the weight average molecular weight, of the organic polymeric resin is about 7 million.

16. The method claim 10 wherein the organic polymeric resin is any organic polymeric resin having an oxygen element therein.

17. The method of claim 16 wherein the organic polymeric resin having an oxygen element therein is selected from the group consisting of polyethylene oxide and cellulose and derivatives thereof.

18. The fundamental bubble solution of claim 1 further comprising a polymeric resin material having a molecular weight, on the weight average molecular weight, less than 2 million so that when the bubbles burst a flake will result.

19. The method claim 10 further comprising a polymeric resin material having a molecular weight, on the weight average molecular weight, less than 2 million so that when the bubbles burst a flake will result.
